(19) United States
(12) Patent Application Publication
(10) Pub. No.: US 2010/0051661 A1
(43) Pub. Date: Mar. 4, 2010

(54) BASKET FOR A RIDING TOY

(76) Inventors: TOM SCHLEGEL, Wheaton, IL (US); Bria Helgerson, Chicago, IL (US)

Correspondence Address: PATENT GROUP;C/O DLA PIPER US LLP, 203 N. LASALLE ST., SUITE 1900, CHICAGO, IL, 60601, US

(21) Appl. No.: 12/200,008

(22) Filed: Aug. 28, 2008

(51) Int. Cl. B60R 9/00

(52) U.S. Cl. 224/400

(57) ABSTRACT

Baskets are described herein that include at least one wall, a floor connected to the at least one wall, a storage cavity, and a gate. The at least one wall has an inner surface, an outer surface, and a front wall portion. Additionally, there is a first opening in the front wall portion, and a second opening in the front wall portion. The gate is located within the storage cavity, and can be pivotally attached to the basket. The gate has an open position and a closed position, and can be detachably connected to the front wall portion when in the closed position.

### BACKGROUND

This disclosure relates to baskets adapted to be attached to the front of a riding toy, such as a bicycle, tricycle, or scooter.

Baskets can be mounted onto riding toys in a forward or rear facing manner. Baskets mounted in a rear facing manner tend to be mounted on the back of the seat, such as a bicycle seat. Baskets mounted in a front facing manner can be mounted to the handlebars of the riding toy.

### BRIEF SUMMARY

Baskets described herein are adapted to be mounted to a riding toy, such as, for example, to the handlebars of a bicycle or tricycle.

Baskets are provided herein that include at least one wall, a floor connected to the at least one wall, a storage cavity, and a gate. The at least one wall has an inner surface, an outer surface, and a front wall portion. Additionally, there is a first opening in the front wall portion, and a second opening in the front wall portion. The floor has an upper surface and a lower surface. The storage cavity is bounded by the upper surface of the floor and the inner surface of the at least one wall. The gate is located within the storage cavity, and can be pivotally attached to the basket. The gate has an open position where the first and second openings in the front wall portion are substantially uncovered, and a closed position where the first and second openings in the front wall portion are substantially covered. The gate can be detachably connected to the front wall portion when in the closed position.

In some examples, the gate can have a first raised portion and a second raised portion. The first raised portion can be received by the first opening in the front wall portion, and the second raised portion can be received by the second opening in the front wall portion, when the gate is in the closed position. In one such example, the first raised portion of the gate can be detachably connected to the first opening in the front wall portion, and the second raised portion of the gate can be detachably connected to the second opening in the front wall portion, when the gate is in the closed position.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 is a front perspective view of a basket having a gate in an open position;

FIG. 2 is a front perspective view of the basket of FIG. 1 with the gate in a closed position;

FIG. 3 is a front view of the basket of FIG. 1 with the gate in the open position.

FIG. 4 is a front view of the basket of FIG. 1 with the gate in the closed position.

FIG. 5 is a side view of the basket of FIG. 1.

FIG. 6 is a rear view of the basket of FIG. 1.

FIG. 7 is a top view of the basket of FIG. 1 with the gate in the closed position.

FIG. 8 is a top view of the basket of FIG. 1 with the gate in the open position.

### DETAILED DESCRIPTION

Baskets described herein are adapted to be mounted to a riding toy. Preferably, a rider can carry one or more items within the basket as they ride on the riding toy. Examples of riding toys include, but are not limited to, bicycles, tricycles, and scooters. The basket can be attached to the front of a ride-on toy, such as, for example, to the handlebars of a bicycle or tricycle. The basket may also be attached to alternative locations, and in alternative positions on the riding toy.

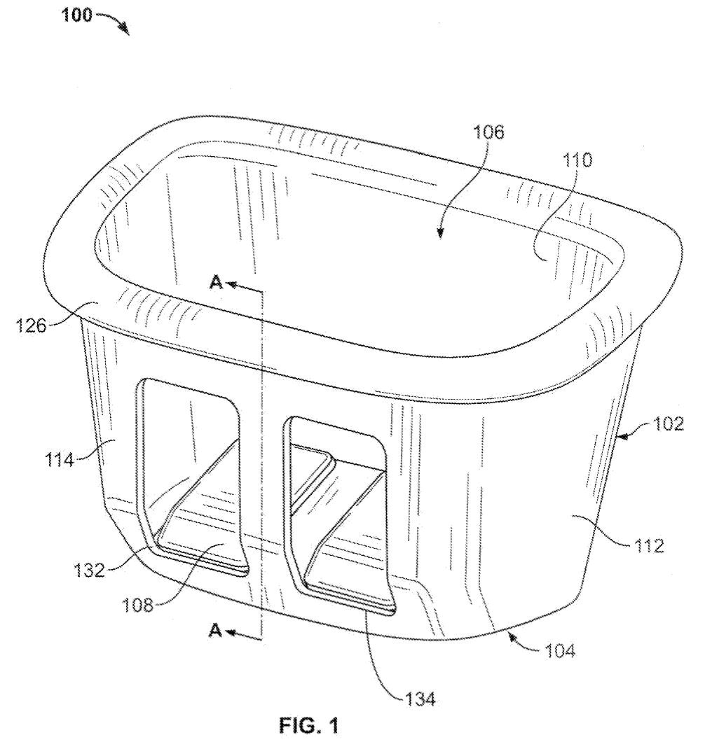

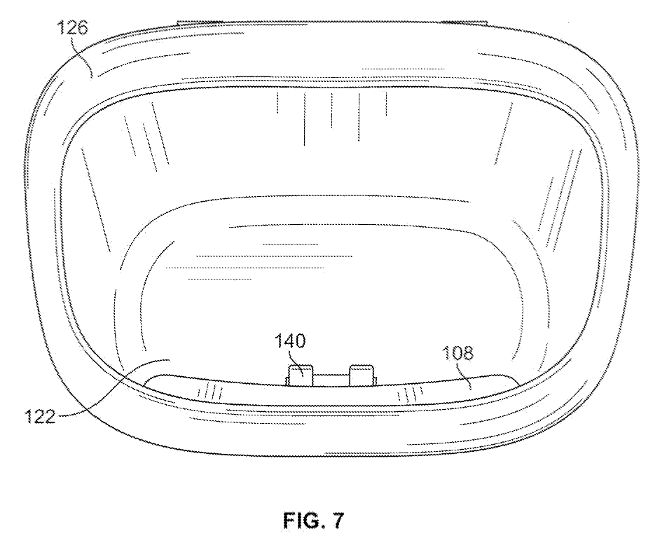

FIGS. 1-8 illustrate one example of a basket 100. The basket 100 can have any suitable shape, such as, for example, a rectangle, or a “D” shape. Further, the basket can have a uniform width and a uniform depth. Alternatively, the basket can be flared or tapered, preferably such that the width, the depth, or both, are greater at the upper end of the basket than at the lower end. The basket 100 has at least one wall 102, a floor 104 that is connected to the at least one wall at the lower end of the basket, a storage cavity 106, and a gate 108.

The at least one wall 102 has an inner surface 110, an outer surface 112, and a front wall portion 114. The wall 102 can be a single piece, which is preferably bent or curved to form the shape of the basket, or can be multiple pieces that are connected to form the shape of the basket. For example, the basket can have a front wall portion 114, a rear wall portion 116, a first side wall portion 118 and a second side wall portion 120. The wall 102, or any wall portion, can be formed from any suitable material, such as plastic, metal, natural materials, synthetic materials, or recycled materials. Similarly, the wall 102 have any suitable structure, such as, for example, being formed from a latticework, or being solid. In the illustrated example, the at least one wall 102 of the basket is solid, and is preferably made of plastic.

The floor 104 has an upper surface 122 and a lower surface 124. Similar to wall 102, the floor 104 can be formed from any suitable material or have any suitable structure. For example, the floor can be plastic, metal, natural materials, synthetic materials, or recycled materials, and can be solid, or formed from a latticework. The floor 104 can have the same material or structure as the wall 102, or can be a different material or structure. The floor 104 can be integrally formed with the wall 102, or can be a separate piece that is attached to the wall 102. In a preferred example, the floor 104 is integrally formed with, or permanently affixed to, the wall 102.

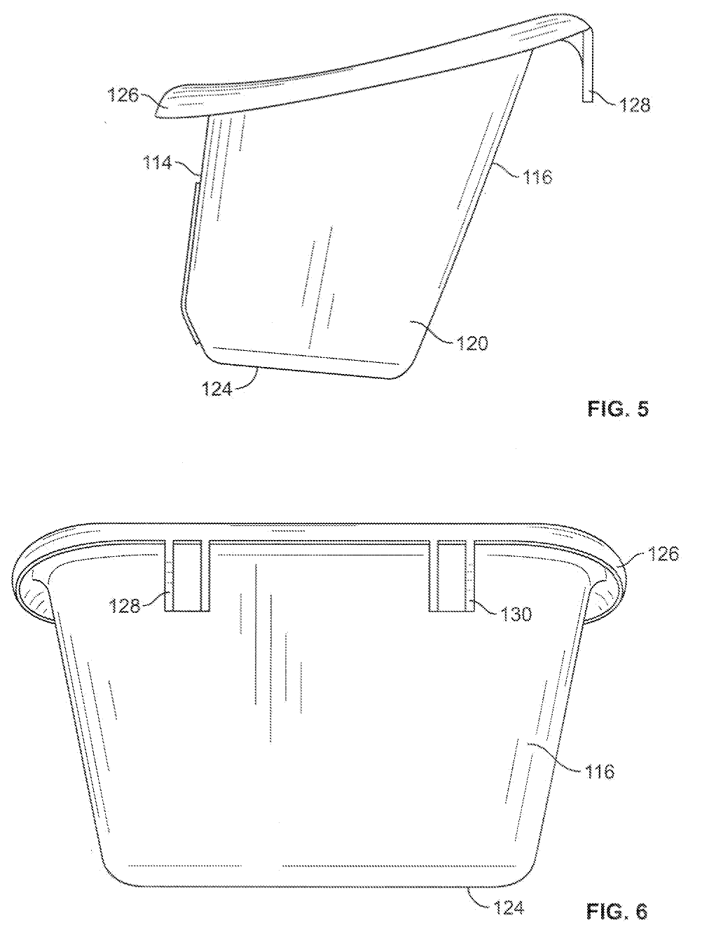

The storage cavity 106 is bounded by the upper surface 122 of the floor and the inner surface 110 of the at least one wall 102. The storage cavity 106 preferably has an open upper end. The basket can have an outer rim 126, which can be connected to the at least one wall at the open upper end of the storage cavity. The outer rim 126 can be integrally formed with the wall 102, or can be a separate piece that is attached to the wall 102. As illustrated in FIGS. 5 and 6, the basket 100 can have at least one fastener, such as hook 128, which is adapted to attach the basket to a riding toy. For example, the basket 100 can have at least two fasteners, such as hooks 128 and 130, which are adapted to attach the basket to handlebars on the riding toy. In such an example, basket 100 can be hung over the handlebars of a bicycle. Preferably, the hooks 128 and 130 can clip onto the handlebars of a bicycle. Alternatively, fasteners can connect a basket to a riding toy by any other suitable means, including, but not limited to, ties, strips having hook and loop connections, brackets, or braces.

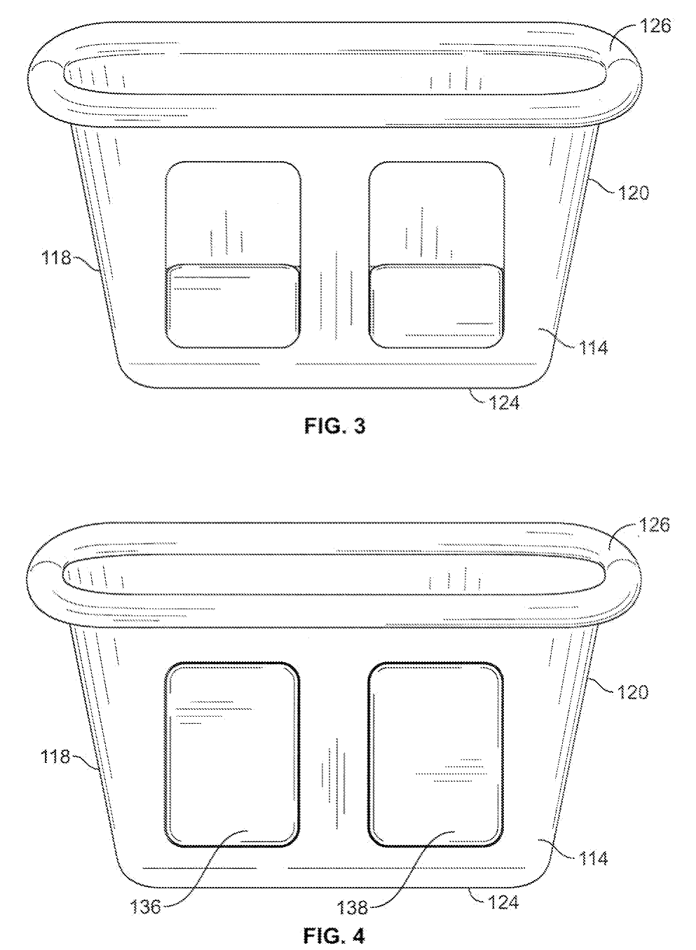

The illustrated in FIGS. 1 and 3, there can be a first opening 132, and a second opening 134, in the front wall portion 114 of the wall 102. The first opening 132 and second opening 134 are preferably adapted to act as leg holes for a child's doll. For example, a doll can be placed within the storage cavity 106 of the basket in a sitting or reclining position, with its right leg protruding through the first opening 132 and its left leg protruding through the second opening 134. As illustrated, the front wall portion 114 has a centerline A. The first opening 132 in the front wall portion 114 is located to the left of the centerline A, and the second opening 134 in the front wall portion 114 is located to the right of the centerline A. The first opening 132 and second opening 134 in the front wall portion 114 can each be any suitable shape, including, but not limited to, a rectangle, a square, a circle, an oval, a triangle, a semi-circle, or a semi-oval. Preferably, the first opening 132 has the same shape as the second opening 134. The first opening 132 and second opening 134 in the front wall portion 114 can each have any suitable size dimensions, such as height and width. In a preferred example, the first opening 132 and second opening 134 in the front wall portion 114 have the same, or substantially the same, size dimensions, and are at least large enough to receive the leg of a child's doll.

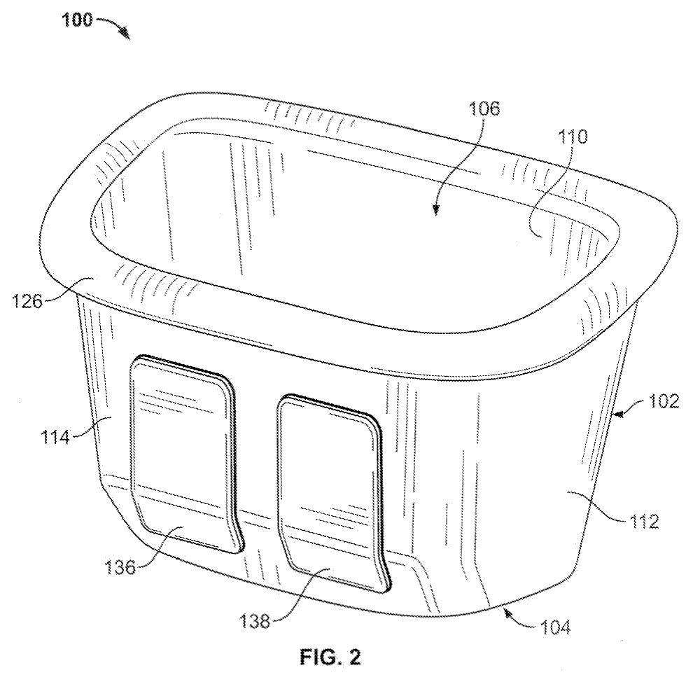

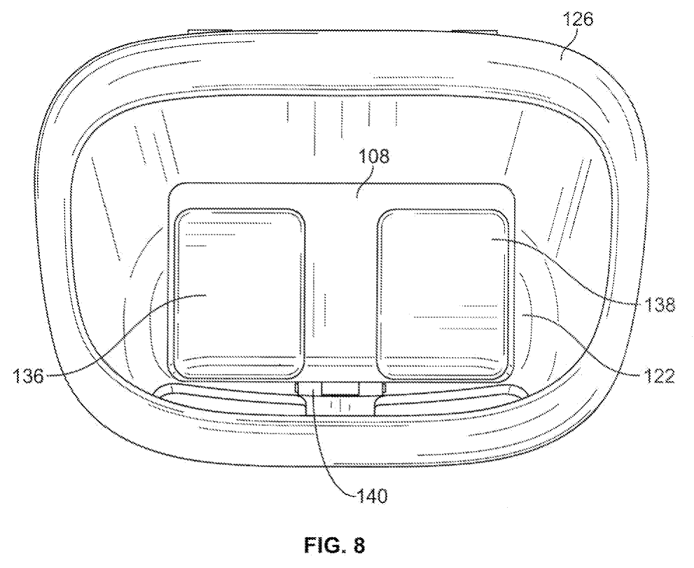

Referring to FIG. 8, the gate 108 is preferably located within the storage cavity 106, and is pivotally attached to the basket 100. For example, the gate 108 can be pivotally attached to the floor 104 or the front wall portion 114 of the basket 100. Preferably, the gate 108 gate is hingedly connected to the front wall portion 114 or to the upper surface 122 of the floor by at least one hinge 140. The gate 108 has an open position, such as that shown in FIGS. 1, 3 and 8, where the first and second openings in the front wall portion are uncovered, or substantially uncovered. Size gate 108 also has a closed position, such as that shown in FIGS. 2. 4 and 7, where the first and second openings in the front wall portion are covered, or substantially covered. Preferably, the gate 108 can be detachably connected to the front wall portion 114 when in the closed position. For example, in its upright closed position, the gate 108 can fit into and cover the first and second openings 132 and 134 in the front portion 114 of the wall 102. When the gate 108 is in the closed position, the basket 100 can be used for storage of any desired items that fit within the storage cavity 106. In its open position, the gate 108 can form a seat, such that a doll can be placed on the seat, with its legs extending through the first and second openings 132 and 134 in the front wall portion 114 of the wall 102.

Referring to FIGS. 2, 4, and 8, the gate 108 can have a first raised portion 136 and a second raised portion 138. The first and second raised portions 136 and 138 of the gate 108 can each have a raised edge, which rises above the remaining portion of the gate 108. The first and second raised portions 136 and 138 can be solid raised portions, as illustrated in FIGS. 2, 4, and 8, or can alternatively be thin raised walls or rims. When the gate 108 is in the closed position, the first raised portion 136 of the gate 108 can received by the first opening 132 in the front wall portion 114, and the second raised portion 138 of the gate 108 can be received by the second opening 134 in the front wall portion 114. Preferably, when the gate is in the closed position, the first raised portion 136 of the gate 108 is detachably connected to the first opening 132 in the front wall portion 114, and the second raised portion 138 of the gate 108 is detachably connected to the second opening 136 in the front wall portion 114. One example of a detachable connection is a friction fit. A friction fit created by the insertion of the first and second raised portions 136 and 138 of the gate 108 into the first an second openings 132 and 134 of the front wall portion 114 can secure the gate 108 in its closed position.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A basket for a riding toy, the basket comprising:
at least one wall having an inner surface, an outer surface, and a front wall portion;
a first opening in the front wall portion;
a second opening in the front wall portion;
a floor connected to the at least one wall, the floor having an upper surface and a lower surface;
a storage cavity bounded by the upper surface of the floor and the inner surface of the at least one wall; and
a gate within tie storage cavity that is pivotally attached to the basket, the gate having an open position where the first and second openings in the front wall portion are substantially uncovered, and a closed position where the first and second openings in the front wall portion are substantially covered, the gate being detachably connected to the front wall portion when in the closed position.

2. The basket of claim 1, wherein the first and second openings in the front wall portion each comprise a rectangle, a square, a circle, an oval, a triangle, a semi-circle, or a semi-oval.

3. The basket of claim 1, wherein the front wall portion has a centerline, the first opening in the front wall portion being located to the left of the centerline and the second opening in the front wall portion being located to the right of the centerline.

4. The basket of claim 1, wherein the gate comprises a first raised portion and a second raised portion.

5. The basket of claim 4, wherein the first raised portion of the gate is received by the first opening in the front wall portion, and the second raised portion of the gate is received by the second opening in the front wall portion, when the gate is in the closed position.

6. The basket of claim 5, wherein the first raised portion of the gate is detachably connected to the first opening in the front wall portion, and the second raised portion of the gate is detachably connected to the second opening in the front wall portion, when the gate is in the closed position.

7. The basket of claim 6, wherein the first raised portion of the gate is detachably connected to the first opening in the front wall portion by a friction fit, and the second raised portion of the gate is detachably connected to the second opening in the front wall portion by a friction fit.

8. The basket of claim 4, wherein the first and second raised portions of the gate each comprise a raised edge.

9. The basket of claim 1, wherein the gate is hingedly connected to the front wall portion or to the upper surface of the floor.

10. The basket of claim 1, wherein the at least one wall is formed from a latticework.

11. The basket of claim 1, wherein the at least one wall is solid.

12. The basket of claim 1, wherein the storage cavity has an open upper end.

13. The basket of claim 12, further comprising an outer rim connected to the at least one wall at the open upper end of the storage cavity.

14. The basket of claim 13, further comprising at least one fastener adapted to attach the basket to a riding toy.

15. The basket of claim 14, having at least two fasteners adapted to attach the basket to handlebars on the riding toy.

16. A basket for a riding toy, the basket comprising:
at least one wall having an inner surface, an outer surface, and a front wall portion:
a first opening in the front wall portion;
a second opening In the front wall portion;
a floor connected to the at least one wall, the floor having an upper surface and a lower surface;
a storage cavity bounded by the upper surface of the floor and the inner surface of the at least one wall, and
a gate within the storage cavity that is pivotally attached to the basket, the gate having a first raised portion, a second raised portion, an open position where the first and second openings in the front wall portion are substantially uncovered, and a closed position where the first and second openings in the front wall portion are substantially covered, the gate being detachably connected to the front wall portion when in the closed position.

17. The basket of claim 16, wherein the gate comprises a first raised portion and a second raised portion.

18. The basket of claim 17, wherein the first raised portion of the gate is received by the first opening in the front wall portion, and the second raised portion of the gate is received by the second opening in the front wall portion, when the gate is in the closed position.

19. The basket of claim 18, wherein the first raised portion of the gate is detachably connected to the first opening in the front wall portion, and the second raised portion of the gate is detachably connected to the second opening in the front wall portion, when the gate is in the closed position.

20. A basket for a riding toy, the basket comprising:
at least one wall having an inner surface, an outer surface, and a front wall portion;
a first opening in the front wall portion;
a second opening in the front wall portion;
a floor connected to the at least one wall, the floor having an upper surface and a lower surface;
a storage cavity bounded by the upper surface of the floor and the inner surface of the at least one wall; and
a gate within the storage cavity that is pivotally attached to the basket, the gate having an open position where the first and second openings in the front wall portion are substantially uncovered, a closed position where the first and second openings in the front wall portion are substantially covered, a first raised portion that is received by the first opening in the front wall portion when the gate is in the closed position, and a second raised portion that is received by the second opening in the front wall portion when the gate is in the closed position.
